(19) United States
(12) Patent Application Publication
(10) Pub. No.: US 2010/0301623 A1
(43) Pub. Date: Dec. 2, 2010

(54) PICK UP SUB

(75) Inventors: Joanne M.I. Dupras, Edmonton (CA); Anthony D. Kadatz, New Sarepta (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: BALDWIN MACHINING & INSTALLATION LTD., Edmonton (CA)

(21) Appl. No.: 12/789,740

(22) Filed: May 28, 2010

(30) Foreign Application Priority Data
May 28, 2009 (CA) 2666790

(51) Int. Cl. B66C 1/42

(52) U.S. Cl. 294/86.4

(57) ABSTRACT

A pick up sub includes a male body with a lifting attachment at a first end and an integrally formed male member with external threads at a second end. The male member is received in mating relation within an interior bore of a female body. At least one nut engages external threads at an extremity of the male member to secure the male body to the female body. The nut fits within a second portion of the interior bore, but is too large to fit within a first portion of the interior bore. A hand wheel is secured to the female body to deliver a jarring impact of a hammer against an anvil when the threaded pin connection is engaged with a box connection of a tubular component, thereby eliminating the need for a wrench or tongs.

### FIELD

There is described a pick up sub that is used to pick up threaded tubular components.

### BACKGROUND

Canadian Patent Application 2,425,619 (Baldwin) describes a pick up sub that is used to pick up threaded tubular components at a well site. The Baldwin pick up sub has a hand wheel that has a hammer and anvil engagement with the body of the sub, so that the hand wheel delivers a jarring impact to eliminate the need for a wrench. When seeking engineering certification, concerns were expressed in safety ratings for heavier loads. This required a different configuration of pick up sub to be developed to accommodate heavier loads.

### SUMMARY

There is provided a pick up sub that comprises a male body and a female body. The male body has a first end and a second end, with a lifting attachment at the first end and an integrally formed male member at the second end. An extremity of the male member has external threads. The female body has a first end, a second end, an exterior surface, and an interior surface defining an interior bore extending axially between the first end and the second end. The exterior surface has a threaded pin connection at the second end. The interior bore has a first portion of a first diameter at the first end and a second portion of a second diameter at the second end. The second diameter is larger than the first diameter. The male member of the male body is received in mating relation within the interior bore of the female body. At least one nut engages the external threads at the extremity of the male member to secure the male body to the female body. The nut fits within the second portion of the interior bore, but is too large to fit within the first portion of the interior bore. A hand wheel is secured to the female body. The hand wheel has inwardly oriented contact members. Rotation in a first rotational direction is limited by a first hammer face on one of the contact members engaging a first anvil on the male body and rotation in a second rotational direction is limited by a second hammer face on one of the contact members engaging a second anvil on the male body. This delivers a jarring impact when the threaded pin connection is engaged with a box connection of a tubular component, thereby eliminating the need for a wrench or tongs.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view, partially in section, of the pick up sub.

FIG. 2 is a top plan sectional view of the pick up sub's hand wheel.

### DETAILED DESCRIPTION

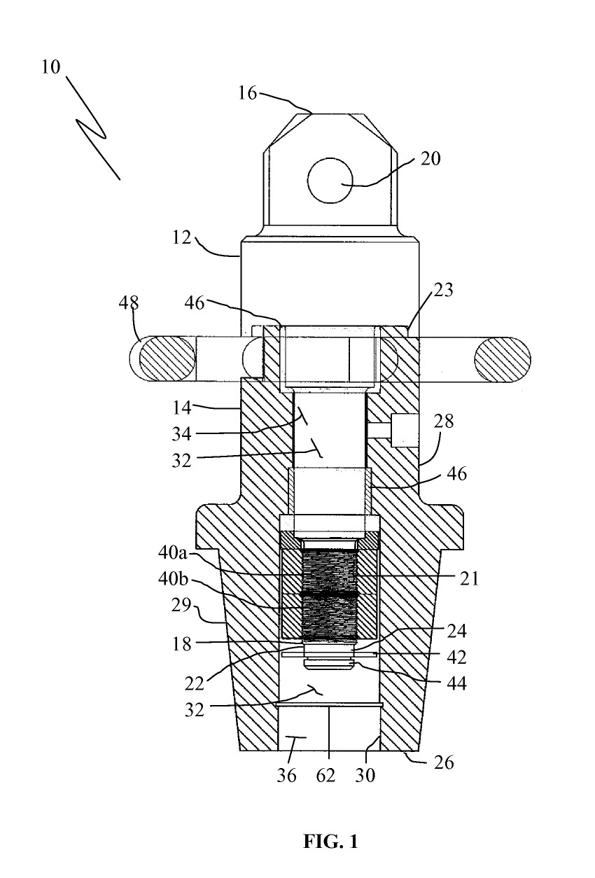

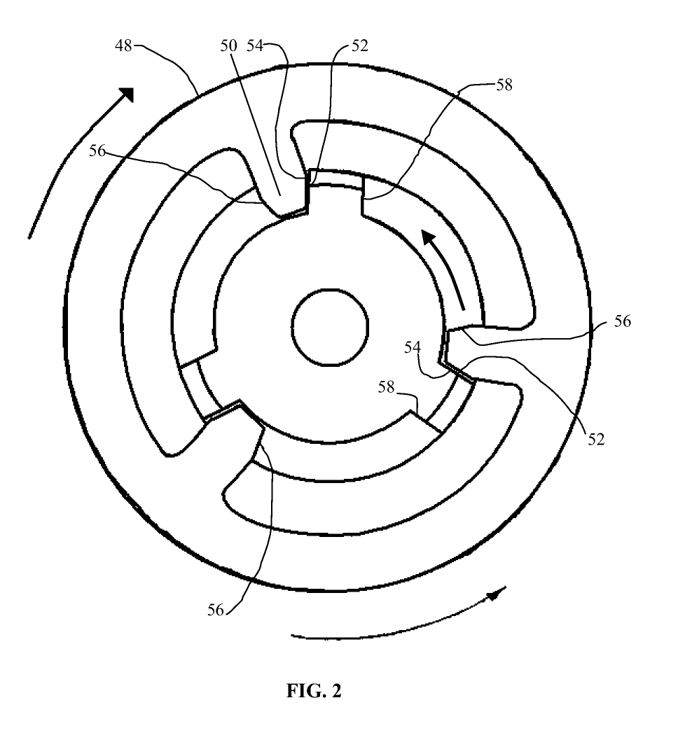

A pick up sub generally identified by reference numeral 10, will now be described with reference to FIG. 1 and FIG. 2.

### Structure and Relationship of Parts

Referring to FIG. 1, a pick up sub 10, includes a male body 12 and a female body 14. The male body 12 has a first end 16 and a second end 18. A lifting attachment 20 is positioned at the first end 16. An integrally formed male member 22 is positioned at the second end 18 which also includes an extremity 24 of the male member 22 which has external threads 21. The lifting attachment 20 is seen in this instance as a lifting eye. The female body 14 has a first end 23, a second end 26, an exterior surface 28, and an interior surface 30 which defines an interior bore 32 extending axially between the first end 23 and the second end 26. The exterior surface 28 has a threaded pin connection 29 at the second end 26. The interior bore 32 has a first portion 34 of a first diameter at the first end 23 and a second portion 36 of a second diameter at the second end 26 with the second diameter being larger than the first diameter. The male member 22 of the male body 12 is received in mating relation within the interior bore 32 of the female body 14. A pair of adjacent nuts 40a and 40b engage the external threads 21 at the extremity 24 of the male member 22 to secure the male body 12 to the female body 14. The nut fits within the second portion 36 of the interior bore 32, but is too large to fit within the first portion 34 of the interior bore 32. A retention washer 42 located at the extremity 24 of the male member 22, where the retention washer 42 serves to prevent the removal of nuts 40a and 40b. The retention washer 42 is held in position by a snap ring 44. A bushing 46 between the exterior surface 28 of the male member 22 and interior surface 30 of the female body 14 facilitates relative rotation of the male body 12 and the female body 14. A hand wheel 48 is secured to the female body 14. Referring to FIG. 2, the hand wheel 48 has inwardly oriented contact members 50. Rotation in a first rotational direction is limited by a first hammer face 52 on one of the contact members 50 which engages a first anvil 54 on the male body 12. Rotation in a second rotational direction is limited by a second hammer face 56 on one of the contact members 48 which engages a second anvil 58 on the male body 12. This delivers a jarring impact when the threaded pin connection 29, referred to in FIG. 1, is engaged with a box connection of a tubular component. Referring to FIG. 1, an end plate seal 62 in the second portion 36 of the interior bore 32 closes the second portion 36 completely.

### Operation

Referring to FIG. 1, the lifting attachment 20 of the pick up sub 10 is connected to an apparatus capable of lifting and moving the pick up sub 10. Once moved into position over a piece of tubular component, the pick up sub 10 is able to move the tubular component by threading the box connection of the tubular component which engages the threaded pin connection 29. The tubular component is locked into position using the hand wheel 48 that is secured to the female body 14. A jarring impact using the hand wheel 48 will cause the tubular component to be locked in place for movement. To release the tubular component, the hand wheel 48 is moved in the opposite direction and with a jarring impact will allow the tubular component to be released from the pick up sub 10.

To accommodate heavier loads, the pick up sub 10 referred to in the above description has a number of safety features. The end plate 62 closes off second portion 36 completely. This prevents nuts 40a and 40b, retention washer 42 and snap ring 44 from falling out of second portion 36 should they fail to remain in proper position. The retention washer 42 and the snap ring 44 prevent the removal of the nuts 40a and 40b. The apparatus is further enhanced by the use of two nuts 40a and 40b. As second nut 40b of the two nuts is used to lock the first nut 40a in position. Male member 12 is created as a single piece, thus making it more difficult for it to fall apart.

The preferred embodiment is described in relation to threaded tubular components at well sites. However, it may also be used at other sites, such as construction, for lifting purposes. Those skilled in the art will recognize that it may be used to perform similar functions in other areas as well.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A pick up sub, comprising:
a male body having a first end and a second end, with a lifting attachment at the first end and an integrally formed male member at the second end, an extremity of the male member having external threads;
a female body having a first end, a second end, an exterior surface, and an interior surface defining an interior bore extending axially between the first end and the second end, the exterior surface having a threaded pin connection at the second end, the interior bore having a first portion of a first diameter at the first end and a second portion of a second diameter at the second end, the second diameter being larger than the first diameter;
the male member of the male body being received in mating relation within the interior bore of the female body;
at least one nut engaging the external threads at the extremity of the male member to secure the male body to the female body, the nut fitting within the second portion of the interior bore, but being too large to fit within the first portion of the interior bore; and
a hand wheel being secured to the female body, the hand wheel having inwardly oriented contact members, rotation in a first rotational direction being limited by a first hammer face on one of the contact members engaging a first anvil on the male body, rotation in a second rotational direction being limited by a second hammer face on one of the contact members engaging a second anvil on the male body, thereby delivering a jarring impact when the threaded pin connection is engaged with a box connection of a tubular component.

2. The pick up sub of claim 1, wherein there is more than one nut.

3. The pick up sub of claim 1, wherein there is a retention washer at the extremity of the male member, the retention wash fitting within the second portion of the interior bore but being too large to fit within the first portion of the interior bore, the retention washer being held in position by a snap ring.

4. The pick up sub of claim 1, wherein at least one bushing is provided between the male member and interior surface of the female body to facilitate relative rotation of the male body and the female body.

5. A pick up sub, comprising:
a male body having a first end and a second end, with a lifting attachment at the first end and an integrally formed male member at the second end, an extremity of the male member having external threads;
a female body having a first end, a second end, an exterior surface, and an interior surface defining an interior bore extending axially between the first end and the second end, the exterior surface having a threaded pin connection at the second end, the interior bore having a first portion of a first diameter at the first end and a second portion of a second diameter at the second end, the second diameter being larger than the first diameter;
the male member of the male body being received in mating relation within the interior bore of the female body;
a pair of adjacent nuts engaging the external threads at the extremity of the male member to secure the male body to the female body, the nut fitting within the second portion of the interior bore, but being too large to fit within the first portion of the interior bore;
a retention washer at the extremity of the male member, the retention wash fitting within the second portion of the interior bore but being too large to fit within the first portion of the interior bore, the retention washer being held in position by a snap ring;
a bushing between the male member and interior surface of the female body to facilitate relative rotation of the male body and the female body; and
a hand wheel being secured to the female body, the hand wheel having inwardly oriented contact members, rotation in a first rotational direction being limited by a first hammer face on one of the contact members engaging a first anvil on the male body, rotation in a second rotational direction being limited by a second hammer face on one of the contact members engaging a second anvil on the male body, thereby delivering a jarring impact when the threaded pin connection is engaged with a box connection of a tubular component.
